(19) United States
(12) Patent Application Publication
(10) Pub. No.: US 2024/0303017 A1
(43) Pub. Date: Sep. 12, 2024

(54) INFORMATION LOGISTICS SYSTEM AND METHOD OF REDIRECTING DATA AND INFORMATION BETWEEN DEVICES AND NETWORKS

(71) Applicants: Mary Lynn Sherwood, Escondido, CA (US); Bruce Lawrence Hall, Escondido, CA (US)

(72) Inventors: Mary Lynn Sherwood, Escondido, CA (US); Bruce Lawrence Hall, Escondido, CA (US)

(21) Appl. No.: 18/626,750

(22) Filed: Apr. 4, 2024

Related U.S. Application Data
(63) Continuation-in-part of application No. 17/661,911, filed on May 3, 2022, now Pat. No. 11,954,393.
Application No. 17/661,911 is a continuation of application No. 16/666,366, filed on Oct. 28, 2019, now Pat. No. 11,321,036.
Application No. 16/666,366 is a continuation of application No. 15/824,336, filed on Nov. 28, 2017, now Pat. No. 10,481,840.
Application No. 15/824,336 is a continuation of application No. 14/793,676, filed on Jul. 7, 2015, now Pat. No. 9,830,115.
Application No. 14/793,676 is a continuation of application No. 12/315,129, filed on Nov. 29, 2008, now Pat. No. 9,098,213.
(60) Provisional application No. 61/004,828, filed on Nov. 30, 2007.

(51) Int. Cl. G06F 3/12; H04N 1/00

(52) U.S. Cl. CPC G06F 3/1296; H04N 1/00209; H04N 1/00236

(57) ABSTRACT

Previous data output devices were designed to print a paper copy of data and/or receipts which causes a disconnect with modern day data manipulation. This logistics system can forward data to and receive data from the internet and hand held devices which will open up extremely fast data exchange and data manipulation for consumers, cities, states and the federal government without the expense of having to purchase complete new systems. By simply interfacing the logistics device (be it a hardware or software implementation) we can connect via wired or wirelessly old computer systems/point-of-sale/databases/etc. to modern day systems which have the ability to manipulate data automatically. This logistics system allows for extraordinary flexibility and improvement of legacy systems, bringing them to the modern Cloud, connected world of devices, without modifying the existing system's hardware.

### CROSS-REFERENCE TO RELATED APPLICATION(S)

This application is a continuation-in-part of and claims priority to U.S. patent application Ser. No. 17/661,911, filed May 3, 2022 which is a continuation of U.S. patent application Ser. No. 16/666,366, filed Oct. 28, 2019 which is a continuation of U.S. patent application Ser. No. 15/824,336, filed Nov. 28, 2017, issued as U.S. Pat. No. 10,481,840 on Nov. 19, 2019, which is a continuation of U.S. patent application Ser. No. 14/793,676, filed Jul. 7, 2015, issued as U.S. Pat. No. 9,830,115 on Nov. 28, 2017, which is a continuation of U.S. patent application Ser. No. 12/315,129, filed Nov. 29, 2008, issued as U.S. Pat. No. 9,098,213 on Aug. 4, 2015, both titled “A PRINTER INTERFACE FOR PRINTING DATA AND/OR RECEIPTS TO AND FROM HAND HELD DEVICES,” claiming priority to Provisional Application No. 61/004,828, filed Nov. 30, 2007, the contents of which are hereby incorporated by reference in their entirety.

### BACKGROUND

The data that old systems contain is very valuable and needs to be used with modern day systems. It would be very costly and time consuming to try to redesign and reprogram all the old systems to output their data to modern day systems. It is equally or even more costly and time consuming to try to print the data to paper and then have to re-enter all the data into the new systems. Since existing printers were designed to output data to paper, they are considered a closed end system with data in and paper out.

In view of the above, various system(s) and method(s) are described that provide an intermediary-based solution to the conventional “printout” approach to provide more flexibility with transaction recording and information saving, dissemination.

### SUMMARY

Printers have always been “end of line devices.” The only function of a printer is to print on paper. We have researched the patents and have found no patent that even remotely describes our invention of using an information logistics system to connect old systems to new modern day systems. The following patents come the closest with the “reuse of data” but even this is about reprogramming the existing system and transferring the data to another paper printer using a network. Various embodiments of the Invention does not change an existing system whereas the existing system works exactly the same but can be connected to modern systems by invoking a “printing” action from the legacy system. From our research it seems that no one has thought to use a printer system to connect modern systems. The following are the patents that come the closest:

| USPTO# | Name | Date |
|---|---|---|
| 7,423,773 | Saeki | Sept 9, |
| 6,842,263 | Saeki | Jan 11, |
| 7,352,487 | Tokashiki | April 1, |
| 7,406,577 | Kaneda | July 29, |

However, since the older computer systems are already programmed to output their data to paper, we have invented a way to “Print” (redirect) this data automatically into new modern day systems. Using our new information Logistics System, we can now connect all old systems with modern day systems by just “printing” (or outputting) to our new “Information Logistics System”. This new information logistics system will take the data from old systems and “Print” it to the internet and/or to databases and/or to hand held devices, other devices/networks so the legacy system can be used in new(er) systems.

This new and novel information logistics system will enable old systems that output data to paper to cause this information to be received from and transmitted to a consumer and/or computer network electronically. This information logistics system can also print to and receive from the Internet automatically.

The ability to do this will open up extremely fast data exchange and data manipulation. Access to this data was not possible before without redesigning and reprogramming all older computer systems.

Using this information logistics system, previous paper data and or receipts can be electronic and be digitally searched, sorted, categorized and totaled automatically. The data can be used in any way necessary for accounting, taxes, product returns, rebates, warranties or any other use that may come up.

In various embodiments, the exemplary system(s) and method(s) provides an Information Logistics System that automatically delivers information, having a First Device that outputs information either wired or wirelessly; a Logistics Device that receives information from the First Device has one or more wired or wireless transmitters to send the information to one or more targeted destinations, wherein the First Device's information can be sent by the Logistics Device to one or more targeted destinations without modification of the First Device.

In other embodiments, the First Device can be any existing object suppling information and can have multidirectional transceivers to input and/or output information to/from the Logistics Device, either wired or wirelessly while using or not using the Electro Magnetic Spectrum. The First Device can be inside, outside or proximal to at least one of; but not limited to Printers, Payment Terminals, Transactional Terminals, other computing devices, networks, and/or buildings and/or in a mode of transportation, such as but not limited to a car, truck, bus, boat, submarine, plane, space object, or other stationary and/or movable object.

In other embodiments, the First Device's function is to supply information to the Logistics Device so therefore the information could come from one of the following but not limited to, a physical device, a virtual device, a software, an API, a Network, a database or the internet. And/or the First Device is any existing object suppling information that it generates, retrieves or receives in real time, in either a digital or analog format, such as but not limited to a receipt, rebate, ticket, an invoice, warranty, product info, text, binary information, images, video, media, email, SMS, coupon, sound, music, financial information such as but not limited to, Credit, Credit Card, Credit Score or rating, Gift Card, loyalty, refund, Bank Check, Bank Certificate, money, token, block chain, crypto currency, bitcoin, payment info, Fintech, GPS information, beacon info, other location info, health care info, AI info, movable object info such as but not limited to, road and highway info, signals, signs, dashboard, image capture, scan capture, OCR, PDA, Voice, picture, Quantum information, login, code, password, personnel information, Camera, light, IoT, touchscreen i/o, voice i/o, and unlimited other types of information supplied by the First Device object. The Logistics Device can be a device, a computing device, a circuit board or a computer chip, that has one or more wired or wireless Transceivers to send and receive digital or analog information to one or more targeted destinations using or not using the Electro Magnetic spectrum, Transceivers could have backwards or forward compatibility with diverse devices and could have one or more computer chips and/or software's to control which inputs or outputs and how they are used. And/or the Logistics Device can be proximal to the First Device so any place that the First Device is located could be where the Logistics Device is located, including inside, outside or proximal to the First Device. However, if the First Device is an object, then the Logistics Device does not have to be proximal to the First Device, and be be able to receive and/or transmit the information that the First Device supplies. Transmission in either direction to the Logistics Device could be through magnetic coupling, direct contact, new or existing specifications such as USB, Bluetooth and wireless networking, radio waves, cell phones, visible light, UV light, infrared, NFC or any other means of receiving the information from the existing system, using or not using the magnetic spectrum. In some embodiments, the Logistics Device can get its target destination Information either pre-programmed or can receive it from—such as but not limited to the First Device, a PRO, a reader, a PDA, by voice, any portable device, a program, a software, link to a program, an app or an API which could be on an internet website, stationary touch monitors, touch monitors in movable objects, modes of transportation information such as but not limited to, signs, highways, streets, street lighting, vending machines, Code cards used or not used with coin, tokens, bitcoin, crypto currency accepting machines, Medical Equipment, Projectors, POS, a flash drive, a memory card, keyboard, USB, GPS, location information or a computer connected to the network and unlimited other types of devices or locations. And/or the Logistics Device can send and receive information automatically to/from, but not limited to, an electronic receipt bank, from a record holding site, a financial service, a bank network, a credit or transaction processing system, consumer's internet account, email, text message, or facsimile, a receipt device, a cell phone network, to and from internet's and/or databases and/or hand held devices and/or future quantum systems and unlimited other types of devices or locations.

And/or the Logistics Device can connect the First Device's Information to new modern day systems or to a consumer and/or computer network electronically so it can be used in new systems through wired or wireless pathway and/or as an alternate pathway an internet/intranet interface and pathway, transmitted in both directions wired or wirelessly from and to various devices and systems. And/or transmitted to and from devices, chips, internets, networks, software's and modes of transportation such as but not limited to, the Internet of Things (IoT) and/or quantum information (qubits) making possible sending and receiving information to and from Quantum Internets or other Quantum networks, Once the Information is on a modern day system or website, in various embodiments it can be accessed via pathway from a computer which could be a federal, state or city computer, an accountant's computer or a personal computer and unlimited other types of devices or locations. And/or the Logistics Device can send and receive information along with additional information, such as but not limited to, a time stamp, date, activity location, activity code, code card and merchant number, while at the same time information such as but not limited to GPS, current location and destination information is added to the previous information and a computer connected to the network validates the information as authentic giving it the ability to send any type of validated and verified information throughout the Information Logistics System which And/or the Logistics Device can, secure, encrypt, decrypt, translate, convert, verify and authenticate, it can also search, find, sort, categorize, format and total automatically, secure multi-way information exchange and/or conversion and/or encryption and/or verification and/or authorization and/or decryption, This information can also be Authenticated and/or Verified information being sent or received with a security and or verification method. For example, by using a code card or other protection device would help prevent identity theft and give the ability to manipulate information automatically. And/or The Information Logistics System can, secure, encrypt, decrypt, translate, convert, verify and authenticate, it can also search, find, sort, categorize, format and total automatically secure multi-way information exchange and/or conversion and/or encryption and/or verification and/or authorization and/or decryption, This information can also be Authenticated and/or Verified information that is sent or received with a security and or verification method. Using a code card or other protection device would help prevent identity theft and give the ability to manipulate information automatically. And/or the Information Logistics System can use the information and added information in such as but not limited to, a report, a tax document, accounting, deposited to the receipt bank, settlement, refund or money due, a receipt, verified receipt, with GPS, real time credit score and balance updates, item names, item categories, store names, dates, times, amounts, taxes paid, locations of the establishment (especially if using out of town deductions) location, GPS, date, time, credits, rewards, settlement info including at least one of but not limited to an amount of refund or money due to a transacting party, itemized transaction information. For example, the amount being transmitted and deposited into the financial service or bank. Or Credit on transaction processing system with or without an illumination verification. The Information for item names, item categories, store names, dates, times, amounts, taxes paid, locations of the establishment (especially if using out of town deductions) can be used for accounting, taxes, product returns, rebates, warranties or any other use that may be needed Some examples of information Name, Address, City, State, Zip, Phone #, email address, credit card numbers, insurance numbers, social security numbers, business card information or any information that the consumer needs to give the seller, business person, company, friend or family member either at a location, over the phone, over the internet, from their personal computer, cell phone where a code card or other protection device would help prevent identity theft.

In some embodiments, the PRO device would be able to receive and transmit information to and from the Information Logistics System. The PRO can also capture and transport information manually when it is needed for returns, warranties, rebates, accounting or taxes. The PRO device could be any new or existing device (or card), an attachment to a device (or card) or even a software program for a new or existing device (or card) or in a mode of transportation. Examples of these devices, at least one of but not limited to flash drives, memory cards, magnetic stripe cards, smart cards, cell phones, PDA or pocket computing devices and would include cameras and projectors. The PRO's information can be used as credit or payment. The PRO device could have special function buttons and a display and would be able to receive and/or transmit information to and/or from the Information Logistics System which could itself transmit and receive from the internet, a network, an external location or even over the phone. The PRO's information of course would be protected from identity theft in addition, for example via a code card or other protection device. In various embodiments, when using the existing Card terminals, existing systems and Credit Card and Gift Card infrastructure for uses different than what they were originally designed for, can be facilitated and the ability to transmit the receipt through an existing “credit card system”.

In various other embodiments, the First Device, the Information Logistics Device, and the PRO device including other devices are used proximal or inside a mode of transportation in conjunction with an touch screen and/or GPS or PDA with voice to enable its use by running software from the internet, as a POS, ATM or payment and credit system in the mode of transportation that is connected to the internet enabling credit and transactions in such as but not limited to, a drive thru environment, to pay bills, do banking, buy groceries and any other transactions, notifications, verification, authentication, identity, communication using cellular network or a 3^{rd} party site or another device or network that can be used in the mode of transportation.

In some embodiments, the First Device, The Information Logistics Device, and the PRO device, including other devices are used proximal or inside a mode of transportation can be used remotely, manually or automatically, they can also be plugged in, built in or stand alone having the ability of communication and information exchange with the internet, 3^{rd} party sites, other modes of transportation, such as but not limited to police, homeland security, emergency, medical, Family, POS, using GPS, shipping, programming GPS for Destinations, highway, financial, buildings, another modes of transportation, devices to supply at least one of notification, identity, verification, authorization, mileage, tickets, receipts, location, image, voice, video, text, SMS, financial and personal information, payments or other information needed that will be secure and initiate payments and/or GPS validated. In some embodiments, the First Device, The Information Logistics Device, and the PRO device including other devices can remotely, manually or automatically, verify the authorization, or identity of user or notification to and from the user and information tabulated on another device, computer or 3^{rd} party site, another computer or mode of transportation programming GPS for Destinations and/or license or other ID when the device connects to the internet when police, homeland security devices or 911 calls, the information will be populated and the verified identity of the owner of at least one of but not limited to voice, face recognition, device, mode of transportation, location for secure identity by encryption and decryption for Authenticated and verified information. Additionally, license plate information could be automatically captured through a reader or other devices and sent through the First Device such as but not limited to a Police, Military, Homeland Security or other mode of transportation's Touch Screen and by using preprogrammed PRO device and/or Logistics Device to automatically get the Driver's History, Vehicle's DMV Registration, Insurance & any other relevant Information from an internet website or other online Databases so it can be used to identify, automate and/or protect on any suspicious traffic stop, threat and/or warning of terrorist activity. The same devices could automatically connect with the Drivers car, Phone, Mailing Address, text or email to send to the driver such things as but not limited to traffic tickets, warnings, accident information, Police Report, bills, invoices, warrants and notifications and the driver could send payments and other information as needed. Once payment was made the driver will receive a receipt.

In various other embodiments, a method to redirect information output locally from a transaction device to non-local secondary devices without requiring an alteration of the transaction device is described, comprising: generating information from a first transaction device; outputting in at least one of a wired and wireless mode the generated information from the first transaction device receiving by a logistics device the generated information from the first transaction device, wherein the logistics device in communication to one or more targeted destination devices; and forwarding the received generated information to one or more targeted destination devices by the logistics device. And/or receiving the generated information from the logistics device by a server within a network Cloud, wherein the server forwards the generated information to the one or more targeted destination devices.

### BRIEF DESCRIPTION OF THE DRAWINGS

FIG. 1 is an embodiment of an information logistics interface that replaces a printer or transaction recording device enabling a computer to connect to modern day systems.

FIG. 2 is an embodiment of an information logistics interface that is connected between a computer and a printer enabling a computer to connect to modern day systems.

FIG. 3 shows how a consumer may obtain a hand held device and how a consumer may receive settlement information on a hand held device after making a purchase.

FIG. 4 shows how a consumer may use the information logistics interface to transfer information to a hand held device enabling the consumer to engage in further transactions.

FIG. 5 is an illustration showing a particular subset of the previous FIGS.′ configuration.

FIG. 6A shows a scenario #1, where “A” is connected to “G” via the previous “legacy” system's connection “B”.

FIG. 6B shows a scenario #2, where the portable device of scenario #1 is removed from the data path, where “G” sends information directly to “I”.

FIG. 6C shows a scenario #3, where the portable device of scenario #1 is removed from the data path and replaced with “H2”.

FIG. 7A shows “A” with a printer port being “plugged into” by “G, communicating wirelessly to “I”.

FIG. 7B shows similar configuration to FIG. 7A, but “G” is connected via a wire/cable.

FIG. 7C shows similar configuration to FIG. 7B, but “I” is replaced by a modern device.

FIG. 7D shows similar configuration to FIG. 7C, but “I” is replaced by a modern device.

FIG. 7E shows “I” replaced by a modern device, shown here as a modern printer.

FIG. 7F is similar to FIG. 7C, however, the modern device is understood to be programmable.

FIG. 7G is an extension of FIG. 7D, where modern device “I” is integral or related to “K”.

FIG. 7H is another extension of FIG. 7D, where modern device “I” is connected to the Internet “H2”.

FIG. 7I is another embodiment, where the modern device “I” is located in vehicle.

FIG. 7J is another embodiment, where modern device “I” is a personal digital assistant (PDA) or similar device (including a voice-controllable device).

FIG. 7K is another embodiment, where the modern device is a combination of “E”+“I” (physical portable device with Internet) that interacts with the new printer system “G”.

FIG. 7L is a modification of the embodiment shown in FIG. 7K, where the new printer system “G” is connected to a receipt printer “C”.

FIG. 8 is a multi-level diagram illustrating different examples of hardware within a system utilizing the exemplary new printer system.

FIG. 9 is a block diagram showing examples wherein the exemplary system is utilized for order and receipt management with commercial or private entities.

FIG. 10 is a set of diagrams showing other examples wherein the exemplary system is utilized to help facilitate the ordering and pickup of food a mall environment.

FIG. 11 is a set of diagrams showing other examples wherein the exemplary system is utilized to assist in vehicle (e.g., location) and road networks, etc.

FIG. 12 is a set of diagrams showing other examples wherein the exemplary system is utilized to help facilitate medical treatment.

### DETAILED DESCRIPTION

This invention has many uses for connecting old output systems to modern systems, devices, databases and the Internet. The following is only one detailed example of use that describes this invention but the example clearly shows how this invention can be used in other similar ways.

Existing computers/point-of-sales print a receipt on paper for the consumer that represents the consumer's transaction. These receipts can get lost, tom, smudged, or turn black from too much heat causing them to be unreadable or unusable. Receipts are extremely important in proving the sale took place. They are important for returns, rebates, accounting, warranties and taxes.

The IRS demands a copy of the transaction as proof for deductions against taxes. If a taxpayer does not have a clear and readable receipt or copy, the taxpayer could be forced to pay more taxes than they actually owe. The other side is also true, with today's paper system there is no way to validate that the receipt is from the taxpayer. The IRS could be forced to accept a receipt that the taxpayer found or was given; therefore it is the Government that is losing out on taxes owed.

This new system would be fair to all and would speed up audits and make it easier for everyone including the IRS, accountants and Taxpayers.

Another problem with receipts on paper is in accounting. Consumers end up with numerous shoe boxes full of receipts that they have to sort, categorize, and total and then have to manually enter these amounts in an accounting system or tax program for yearly taxes.

This is confusing, extremely inefficient, time consuming and costly, especially if the consumer has to pay an accountant to do the work. Since all receipts have totally different formats and layouts, it is very frustrating, difficult and time consuming to manually search for item names, item categories, store names, dates, times, amounts, taxes paid, locations of the establishment (especially if using out of town deductions), etc. Whereas Electronic sorting is almost instantaneous for all.

Transmitting and receiving this information to and from the consumer could be done in two basic ways. The first way is physically.

If sent physically then the consumer could carry A PORTABLE RECORD ORGANIZER device or (PRO) that would be able to receive and transmit information to and from the new information logistics interface system.

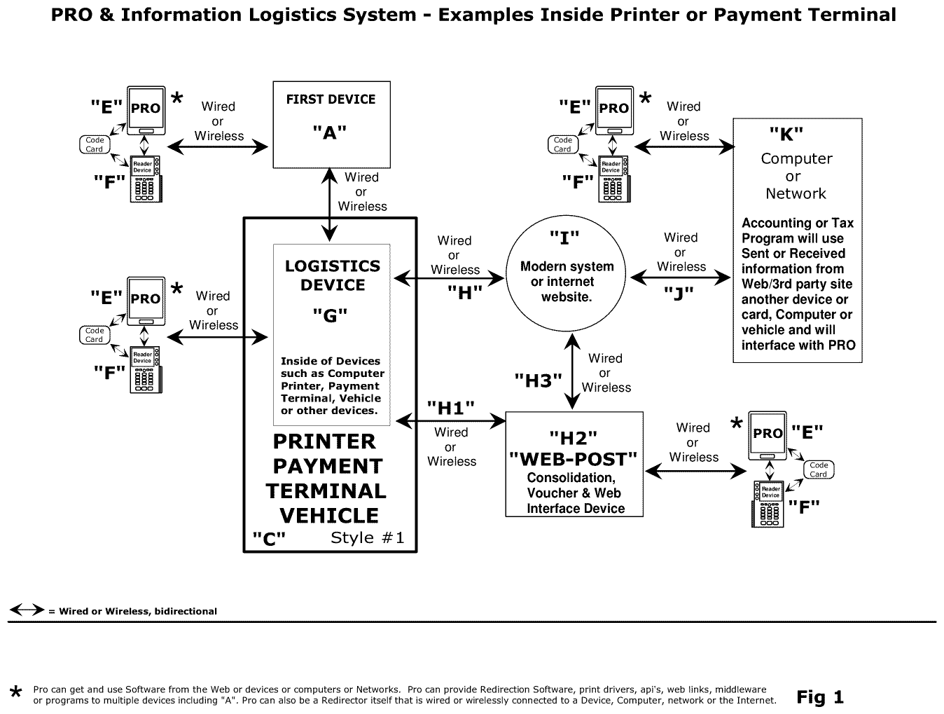

The advantage of this invention is that there is no need to reprogram or in any way modify the old system. There are two styles of the same invention shown. Style #1 (as depicted in FIG. 1) is the Interface G installed into a printer or payment terminal (for example, located in a vehicle) C so you can connect old systems to new modern day systems or the internet by simply replacing the original “printer” device to connect to modern day systems, for example, I, K, H2, etc., as well as to other (new or legacy) devices F.

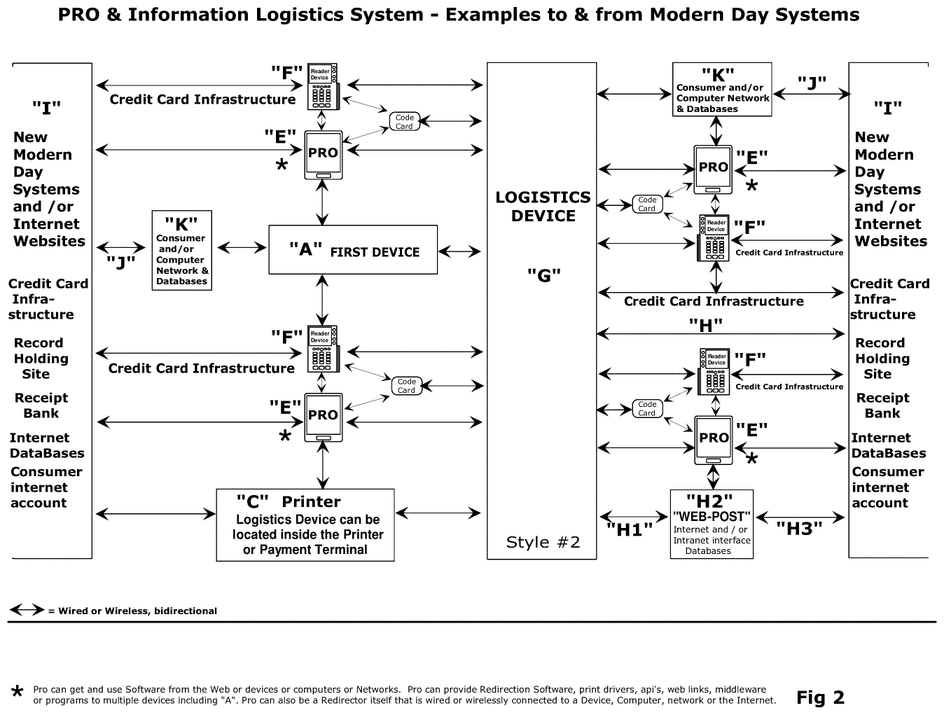

Style #2 (as depicted in FIG. 2) is the same exemplary interface G that is connected between the old system (e.g., A) and the old printer (e.g., C) so you don't have to replace or modify anything. By simply adding the interface G, you can use the old system and the old printer to connect old systems to new modern day systems or the Internet (I, H, H2, K, etc.). FIG. 2 is an embodiment of an information logistics interface G that is connected between a computer A and a printer C enabling a computer to connect to modern day systems.

The operation of Style 1 (as depicted in FIG. 1), will in turn describe Style 2 (as depicted in FIG. 2) with the same references.

Referring to FIG. 1: The user will “unplug/reset” the old printer/payment terminal “C” from the existing printer cable (not shown) or communication pathway (e.g., wireless) and plug in new logistics system “G” via wire or wireless as a printer/terminal proxy to the first device A—which is generating the receipt or data to be output to the former destination (printer C). The system is unchanged but now has the capability to transfer data originating from device A to and from the modern day systems or an Internet website through wired or wireless pathway “H” and/or as an alternate pathway “H1” an Internet/intranet interface “H2” and pathway “H3”. The data can also be sent to a hand held device (e.g., PRO) or card “E”. A reader “F” could read a hand held device or card “E” to get the address of the computer or website or destination device to send the outputted information to.

Please note the data is transmitted in both directions from and to “E” “F”, “D”, “G”, “H”, “HI” “H2”, “H3”, “I”, “I”, “K” and also from “G”, “B” and “A”.

Once the data is on a modern day system or website “I”, it can be accessed via pathway “J” from computer “K” which could be a federal, state or city computer, an accountant's computer or a personal computer. Note that by using the Portable Record organizer (PRO), a hand held device or a card “E” you can transport the modern day information manually from computers or websites to a detached computer “K”.

Transmission in either direction to the new logistics system could be through magnetic coupling, direct contact, new or existing specifications such as USB, Bluetooth and wireless networking, radio waves, cell phones, visible light, infra red or any other means new or existing that uses the electro-magnetic spectrum.

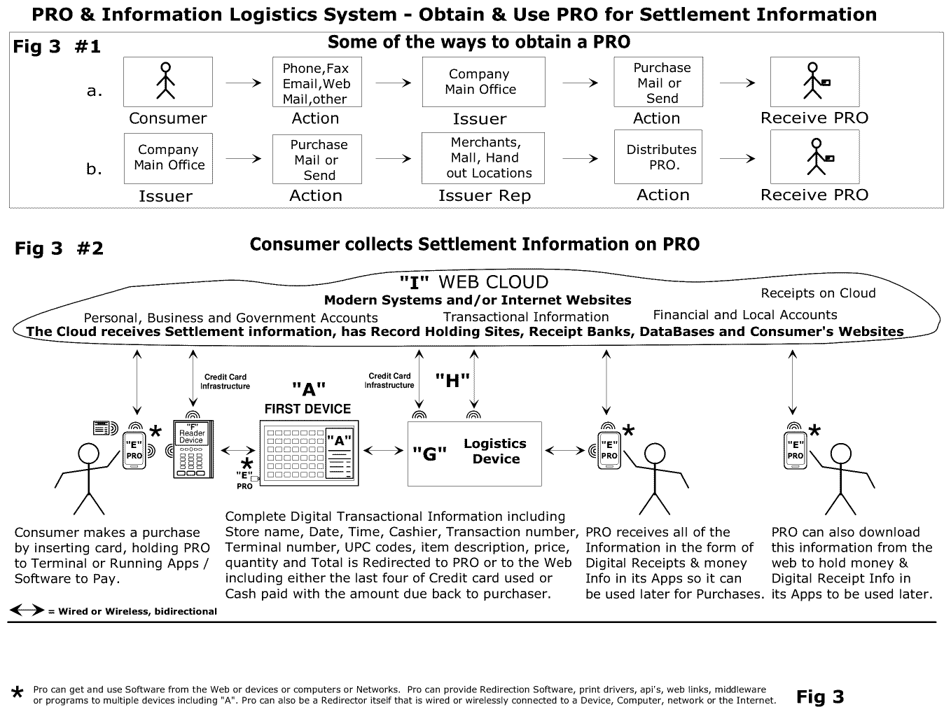

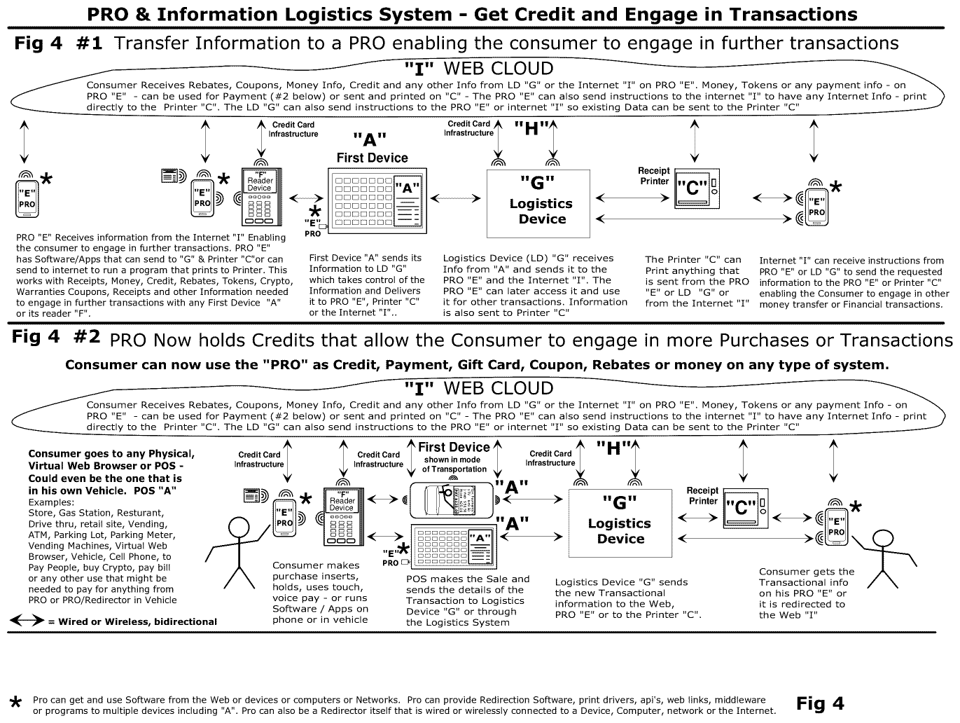

The PRO (for example, as shown in FIG. 3 & FIG. 4) works with the new logistics system and could be any new or existing device (or card), an attachment to a device (or card) or even a software program for a new or existing device (or card). Some examples of these devices (but not limited to these) would be flash drives, memory cards, magnetic stripe cards, Smart cards, cell phones, smart phones, PDA′ or pocket computing devices.

FIG. 3 shows examples of the exemplary system being used to obtain settlement information as per a real estate related transaction. FIG. 3 demonstrates two possible approaches (#1 and #2) how a consumer may obtain or use a hand held device (e.g., PRO) to receive settlement information on a hand held device (PRO) after making a purchase. Paths “a” and “b” of way #1 show the possible PRO procurement steps when the action is initiated from a consumer vs. the issuer and is understood to be self-explanatory.

The #2 approach in the bottom of FIG. 3 illustrates the use of the consumer's PRO to initiate the transaction, noting the sequence follows from left-to-right and utilizes an exemplary logistics device G to facilitate the transaction, aspects of the information being generated being placed into the Cloud and “other” PRO's authorized to engage in the transaction.

FIG. 4 shows two examples (#1 & #2) wherein the exemplary system enables a consumer to use the logistics device in combination with a PRO for credit and other financial transactions. In the first scenario #1, the PRO device is consumer-“held” and alleviates the need for the consumer to interact with other devices managing the transaction at hand.

That is, the PRO provides the appropriate interfaces and information for use and/or observation by the consumer. In scenario #1, information such as a credit or rebate, etc. is transferred to the PRO, wherein the information is used to enable the customer to conduct further transactions. A non-limiting sample suite of possible transactions for use of this system is listed in the FIG.

Scenario #2 proceeds with completion of #1, for example, a credit to the customer's account. Now, the customer can exploit the “money” in his account by transferring it, for example, for a purchase at a retailer, etc. The PRO here is able to act as a Cloud gateway for the retailer's devices (a credit card reader, POS, etc.) shown here as “A” (which is managing the transaction). In one of many possible pathways, the received information by the PRO (from the first device A) can be forwarded to the logistics device G for Cloud storage “I” or invention-specific management/account control. With transaction data stored on the Cloud “I”, it can be then reviewed later, managed, etc. by the customer post-transaction, if so desired. As apparent from the direction arrows in the FIGS., other paths for the information may be taken, depending on implementation and desires. Note that in FIG. 4 we are using the PRO data as credit or payment though the first device's “A” system.

In the case of specially made device, it could be as simple as a modified flash drive or more specific such as a Portable Record Organizer (PRO) that could have special function buttons and a display and would be able to receive and/or transmit information to and/or from the new logistics system which could itself transmit and receive from the internet, a network, an external location or even over the phone.

Some examples of the information received from the consumer could be Name, Address, City, State, Zip, Phone #, email address, credit card numbers, insurance numbers, social security numbers, business card information or any data that the consumer needs to give the seller, business person, company, friend or family member either at a location, over the phone, over the internet, from their personal computer or cell phone. This of course would be protected from identity theft.

The second way is to transmit and or/receive information over the Internet from or to the new logistics system. This could be done by sending or receiving to or from a consumer's internet account or sending or receiving to or from a “record holding site: such as a “Receipt Bank” were the consumer could upload or download information to or from their personal computer and/or PRO device or cell phone and/or the new logistics system when they need to use it for returns, warranties, rebates, accounting or taxes.

This will be done in a quick “stair step” fashion for fast adoption and use. We can implement a quick and easy logistics system interface that will enable us to use the information that was previously going to existing printers (or output devices) without modification to the existing system or its software.

This will consist of connecting a new logistics system that would receive and/or transmit information to the new logistic system and enable sending it to a Portable Record Organizer as described above. This interface could be in line with or inductively coupled to the existing system.

This interface could also include any other means of receiving the information from the existing system. The design and interface for the new logistics system could also be licensed to various manufactures to be incorporated into their printers/output/transaction devices thereby giving extra value to their current legacy devices.

Neither of these uses would change the existing older system operation but would enable the immediate connection to all new modern Systems throughout the world and allow the consumer to electronically transmit and/or receive their information physically on a Portable Record Organizer, which is then downloadable to the consumer's personal Computer.

The next step would be to transmit and/or receive this information to or from the Internet where it could be uploaded, stored and downloaded by using a code card or other protection device connected to the new data printer and needed for identity theft. It can be accessed and used at any accounting office or location virtual or physical designated by the owner or even on the owners' own personal computer, smart phone, vehicle, etc.

This could be done simply by using the above-mentioned physical devices. This device will connect to the Internet and “record” the receipt, rebate, warranty, and other information to or from a storage site on the internet or intranet.

Note: Using the existing Credit Card terminals, existing systems and Credit Card and Gift Card infrastructure for uses different than what they were originally designed for is also within the purview of this disclosure.

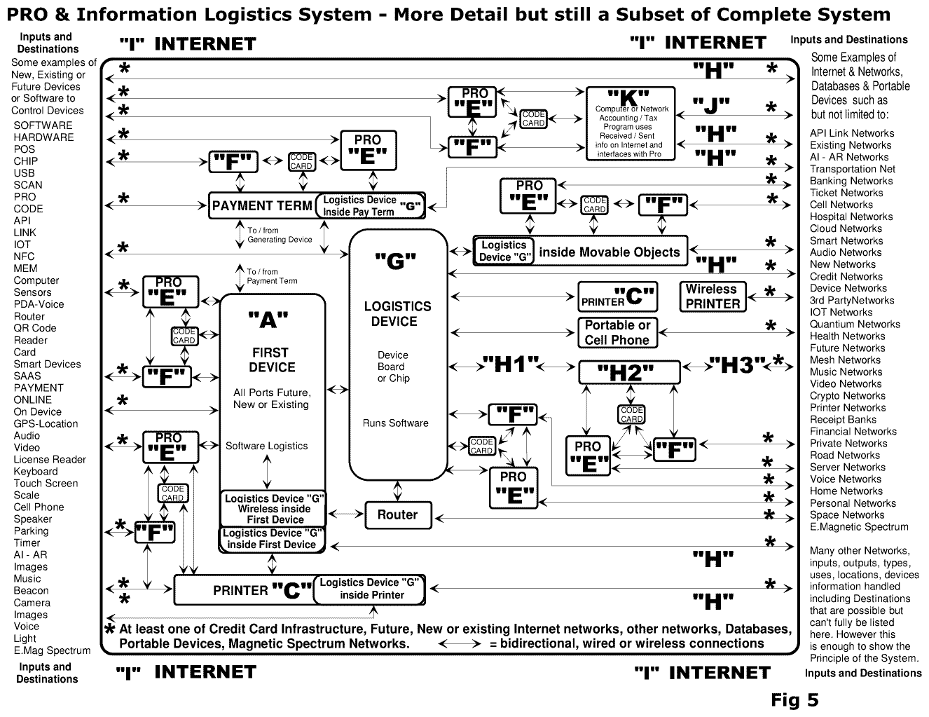

FIGS. 5-8 below are drawings of various features shown in the previously illustrated FIGS., but now illustrated in particular subsets or combinations, to better describe some of the scenarios desired.

FIG. 5 is an illustration showing a particular subset of the previous FIGS.′ configuration. Existing computer system, point-of-sale, transaction device “A” can be connected to the New Logistics System “G” via a printer cable or some other connection type “B.” As further discussed herein, the connection can be a USB connection, wireless, internal and any type of connection desired. Printout or transaction information from “A” is forward to “G” which is then forwarded unaltered or altered to any one or more of five different devices “C” (existing old printer), “H2” (Web-Post), “F” (Reader Device), “E” (Portable Device/Smart Phone), and “I” (Internet/Website). Any of the communications to the various different devices can be via wired and/or wired channels and can be bi-directional. “F” and “E” can be separately linked together, to exchange information, for example, “F” can be a credit/card reader, bar code scanner, or other device/memory reader. “H2” can communicate also with “I”, to provide consolidation, Voucher, Web interface information, as needed.

“I” can receive information from “G”, “E”, “H2”, as well as from “K” (computer network with software). It is noted that “E” can contain one or more “input” capabilities such as Magnetic card, chip, RFID, memory stick, Flash, Software input and so forth. “E” can communicate directly with “K” via its own channels or via “I”.

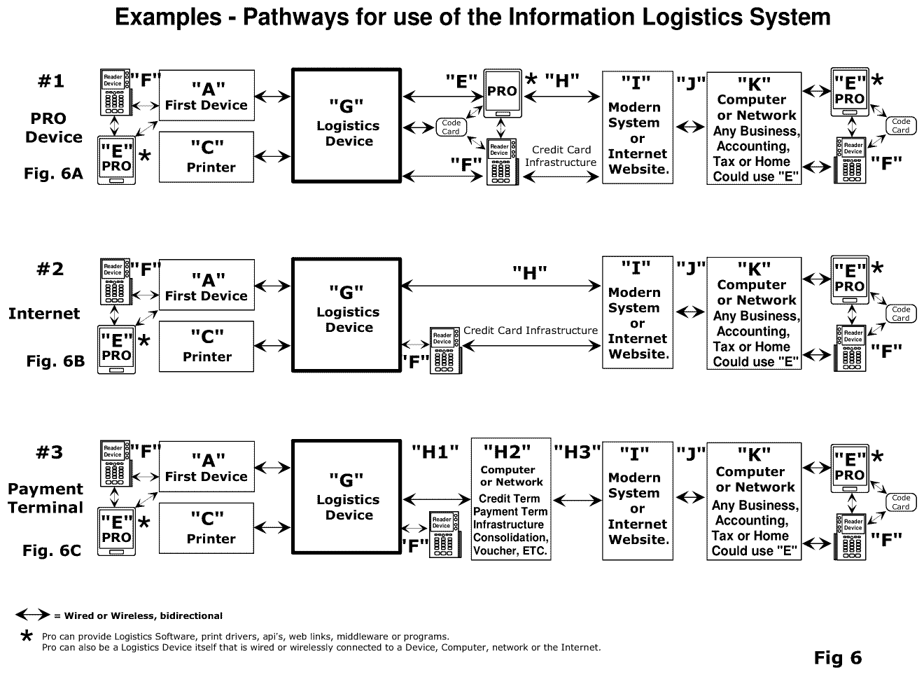

FIGS. 6A-C show different pathway/device options. FIG. 6A shows a scenario #1, where “A” (existing computer/point-of-sale, transaction system) is connected to “G” (new logistics system) via the previous “legacy” system's connection “B” (e.g., existing printer cable). “G” is placed intermediary to “A” and the “C” (e.g., existing printer) and can output/print/store to “C” if so desired. “G” takes output information generated from “A” and can connect to “E” (portable device” via “D” (wired or wireless connection). Similarly, “F” (reader) is connected to both “G” and “E”, where “F” can provide read information to “G” and/or “E”. The portable device “E” may have software running on it to allow it to communicate information from “G” (and/or “F”) to “I” (system/Internet Website)—presumably the Internet Cloud. “I” then can convey information with respect to the output information from “A” to “K” (computer or software). Here, it is understood that “E” may have software capabilities and commands that interact or provide instructions to “K”. For example, output information could be selected to be sent to a customer's specific business/personal program via an action choice in “E” 's program/menu. Of course, other possibilities and choices are possible.

FIG. 6B shows a scenario #2, where the portable device of scenario #1 is removed from the data path, where “G” sends information directly to “I”. Also, “F” only corresponds with “G”. A program may be placed in “G” that automatically sends the output information to the desired destination in “K” and/or “F” provides destination information. For example, a card reader (credit card company XYZ, as one possibility) would tell “G” to forward the output information for the customer using the credit card to XYZ's software/account on “K” pertaining to the customer. Of course, other possibilities and choices are possible.

FIG. 6C shows a scenario #3, where the portable device of scenario #1 is removed from the data path and replaced with “H2” (computer or network or credit term, payment term infrastructure, consolidation, voucher, etc.). A terminal/computer with or without pertinent software can act as the gateway (with instructions/destination information) for the output information.

The above FIGS. 6A and 6C illustrate different “mechanisms” or scenarios where the output information is channeled or directed via an intermediary “E” or “H2” which can have destination and/or customer specific information as well as selection options for the customer. Of course, “F” can provide additional information, if so desired. FIG. 6B relies on “G” as the only intermediary to “I” (with “F” again providing additional information, if so desired).

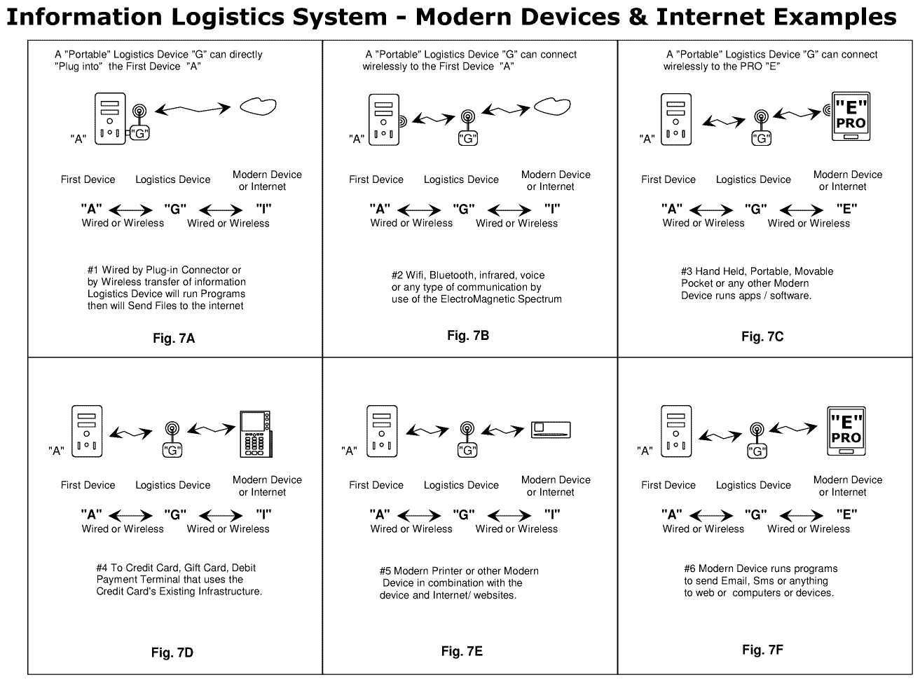

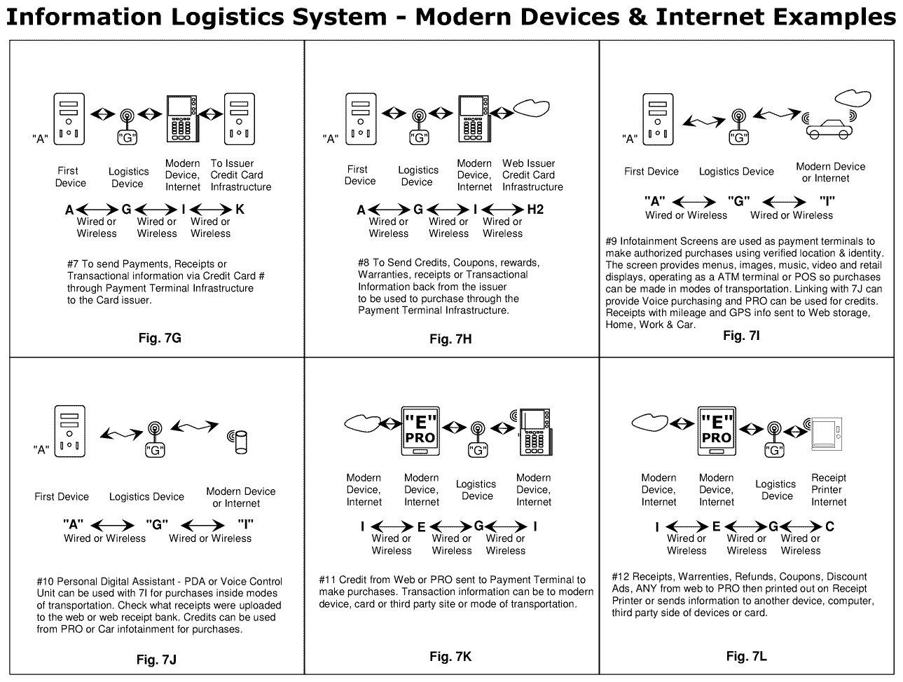

FIGS. 7A-L are illustrations of alternative scenarios, showing specific embodiments. FIG. 7A shows “A” with a data port being “plugged into” by “G” (new logistics system), communicating wirelessly to “I” (modern device or Internet). “G” has one or more programs to assist in redirecting the output information to the Internet.

FIG. 7B shows similar configuration to FIG. 7A, but “G” is connected via a wire/cable. Also, wireless communication is contemplated as via Wifi, Bluetooth, infrared, voice or any EM communication.

FIG. 7C shows similar configuration to FIG. 7B, but “I” is replaced by a modern device, shown here as a smart phone, hand held portable, etc. that is capable of running programs.

FIG. 7D shows similar configuration to FIG. 7C, but “I” is replaced by a modern device, shown here as a terminal device that can be a credit card, gift card, debit payment system that interfaces with conventional credit processing infrastructures.

FIG. 7E shows “I” replaced by a modern device, shown here as a modern printer (in contrast to the existing “printer”). Additionally, the modern device can be a wireless gateway to the Internet.

FIG. 7F is similar to FIG. 7C, however, the modern device is understood to be programmable, running software and having a suite of communication programs, such as email, SMS, etc.

FIG. 7G is an extension of FIG. 7D, where modern device “I” is integral or related to credit card/financial institutions with computers/servers “K” providing support and processing of the output information.

FIG. 7H is another extension of FIG. 7D, where modern device “I” is connected to the Internet “H2” where account or other information is returned from the Internet “H2” to instruct/manage the modern device's “I” handling of the output information. As shown in this FIG., Credit information such as authorization for payment, purchase is facilitated. Of course, other types of information exchange is possible.

FIG. 7I is another embodiment, where the modern device “I” is located in mode of transportation, shown here as an automobile, but is understood to be any vehicle of transport, including airborne, seaborne, non-terrestrial, etc. Various “receipt” scenarios are possible, for example, an Automated Teller Machine (ATM) could operate as part of “A”+“G” system.

FIG. 7J is another embodiment, where modern device “I” is a personal digital assistant (PDA) or similar device (including a voice-controllable device).

FIG. 7K is another embodiment, where the modern device is a combination of “E”+“I” (physical portable device with Internet) that interacts with the new logistics system “G”. Here, it is contemplated that information (e.g., credit) to a smart phone/cell device from the Web is also sent to payment terminal/modern device “I” that is connected to the new logistics system “G”.

FIG. 7L is a modification of the embodiment shown in FIG. 7K, where the new logistics system “G” is connected to an originally targeted device, for example a receipt printer “C”. Here, it is contemplated that information for a transaction, for example, receipts, warranties, refunds, coupons, discount (ads), or any such related information from the Web is forwarded to the targeted printer “C” for printout. It is noted that the A-device outputted information may be forwarded to multiple target devices, using the logistics system to facilitate different target(s) device than those contemplated by the original system.

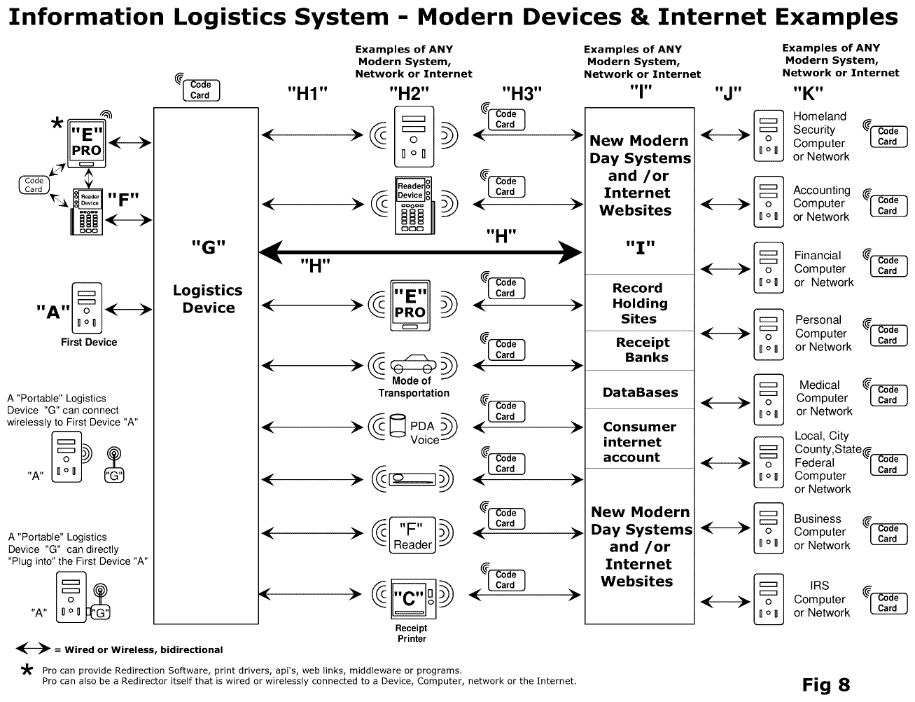

FIG. 8 is a multi-level diagram illustrating different examples of hardware that may be instituted for connection and communication within a system utilizing the exemplary new logistics system. For example, an information output generating device “A” is bidirectional and coupled wirelessly or via wire to the new logistics system “G”, having either wired or wireless communication capabilities “H1 which can communicate to an intermediary device “H2” and from “H2” to a modern system/network/Internet “I”, or directly to a modern system/network/Internet “I”. As shown in the bottom left corner of FIG. 8, an embodiment is contemplated wherein the information generating device “A” is either plug-in coupled or wirelessly to the new logistics system “G”.

From “I” the output data from “A” and, optionally, any assorted commands, information from “G” and/or “H2” is forwarded wired or wirelessly “J” to a target modern system/network/Internet “K” that may have servers, computers, databases that hold and/process the output information (with optional “G”, “H2” information).

This configuration shows the various paths that the output information can take to ultimately arrive at the servicing server/target system “K” and facilitate, for example, an “A” initiated transaction. The target system “K”, during or after processing the forwarded information, can perform account verification, debits, credit, financial, accounting, security and other assorted actions to facilitate the initial transaction from the “A” system. As detailed above, the target system “K” can send a return signal or information content back to the various devices in the original path. Thus, a user can perform a purchase at “A”, review the purchase at “H2” and perform any desired action, wherein the transaction details are forwarded to, for example, a credit card processor “K”. Handshaking and transaction security/initiation/authorization can occur between “K” and “A” and “H2”, wherein the user (on “H2”) for example can authorize an initiated transaction from “A”, which is forwarded to “K”—enabling “K” to complete the transaction activity. Thereafter, “A” can forward a receipt or other transaction detail (e.g., email, text, etc.) to “H2” as well as to “K”, if so desired. Of course, “K” may send its record of the transaction directly to “H2”. In view of the device/examples shown in FIG. 8, numerous other possibilities and options contemplated and available and understood to be self-explanatory.

Previous output devices, such as printers, were designed to print a paper copy of data and/or receipts which causes a disconnect with modern day data manipulation. This exemplary logistics system can forward, print, record, store data to and receive data from the internet and other modern day systems which will open up extremely fast data exchange and data manipulation for consumers, cities, states and the federal government without the expense of having to purchase complete new systems. By simply changing out an old, legacy hardware we can connect all old computer systems with modern day systems that now have the ability to manipulate data automatically. Example: consumers and accountants no longer have to go through weeks of finding, sorting and compiling receipts of paper to do their taxes. The government can do extremely fast audits with far fewer auditors—automatically. Consumers pay only what they owe which can be collected immediately without a stressful audit for the consumer. The consumer can collect their refund immediately, which is needed to stimulate the economy at this time.

In view of the above, the following FIGS. are presented to show various non-limiting examples of one or more implementations of the capabilities described above for the exemplary system(s) and method(s). And how the invention can provide many value-added features to routine transactions being conducted in normal life.

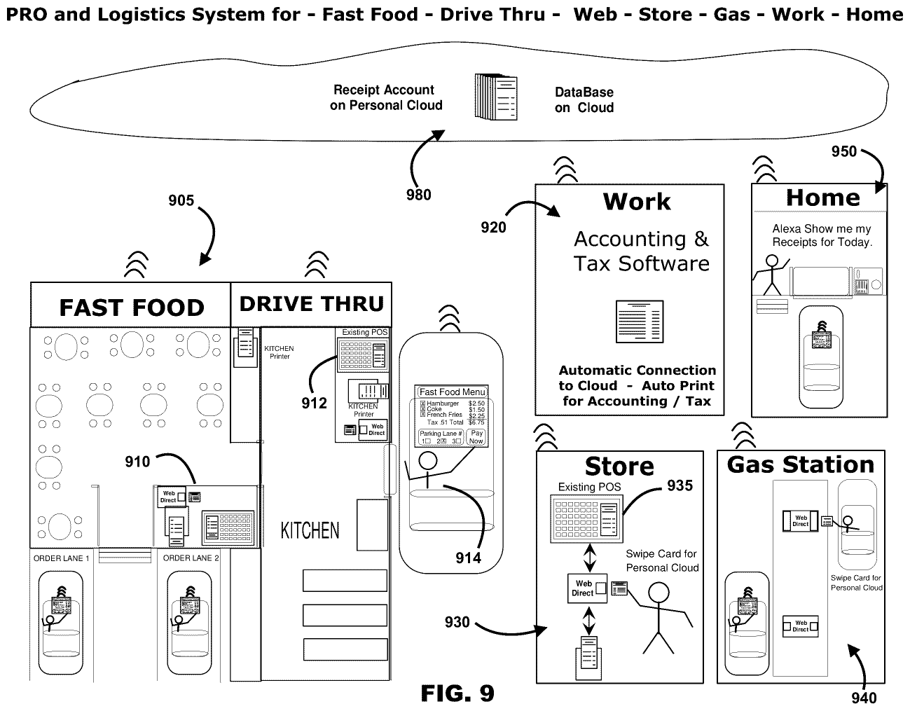

FIG. 9 is a block diagram showing examples wherein the exemplary system is utilized for receipt management with one or more fast food restaurant(s) 905 having ordering kiosks 910, kitchen-side POS 912 with drive-through customer 914 with PRO connectivity; a tax office 920; a retail store 930 with visible POS terminal 935; a gas station 940; and a home 950. All having the requisite PRO features in the respective environment via an app or hardware-linked in/to the electronic servicing computer(s) of the service or goods provider, being connected to an exemplary cloud server 980 containing the requisite supporting PRO programs, databases and other connections (not shown) and the customer's transactions. And in some embodiments, the cloud server 980 may contain a personal cloud, dedicated to the user/customer's transactions. Any one or more of the systems and methods described in the prior FIGS. can be implemented into the various settings shown, noting FIG. 9 helps to illustrate a simple sample set of the variety of possible environments that will benefit from the invention's use. For example, a home 950 user may invoke an Amazon service to review all sales receipts (Amazon or otherwise from other retailers) that were generated using the invention. Or, for a customer 932 at the retail store 930 swiping their store card 934 to purchase an item to be duplicate-recorded to a Personal Cloud 935. The Personal Cloud 935 could be a private database, for example, at the consumers Home, or on a Cloud with Private services, or at a Receipt bank, or at an online banking account or at a credit Card Company. The Personal Cloud 935 could send receipts to other destination or requested places.

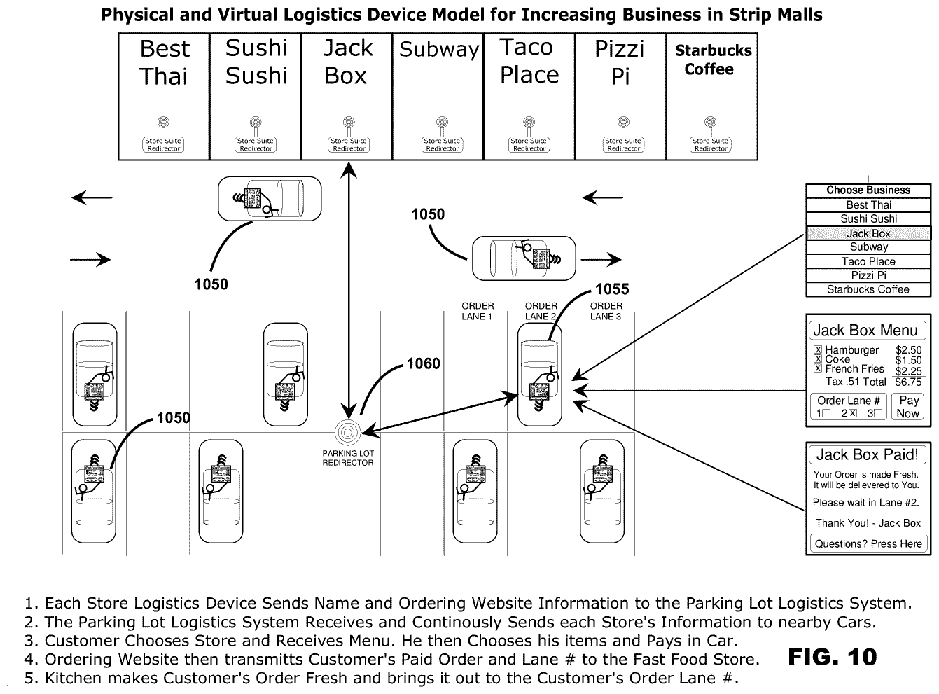

FIG. 10 is a set of diagrams showing other examples wherein the exemplary system is utilized to help facilitate the ordering and pickup of food from one or more “fast food” restaurants, for example, in a strip mall's parking environment. Here, the consumer-side exemplary PRO device/system/method is in the various vehicles 1050 (1055) shown (either as part of the vehicle's software, and/or on a user's phone/smart device separate from the vehicle's software). Each store's POS system is in connection within a vehicle's PRO system (for example, on a user's app, on a vehicle screen, etc.) and facilitates the ordering of items between several different food service restaurants. And in combination with the parking lot redirector 1060 can coordinate the “traffic” between the parked (in waiting) vehicles 1050 (1055) to manage the ordering and pickup/drive through. It is understood that the parking lot redirector 1060 need not actually be in the parking lot nor need be a separate device (it may be a software element running in coordination with a user-located “app” or device). In this FIG., the example elaborated is for a customer in vehicle 1055 ordering from a Jack Box restaurant, wherein the customer, after ordering, is directed to lane 2 for pickup. This diagram shows the ability of the exemplary PRO system to be integrated into goods and services, such as order making and related traffic control.

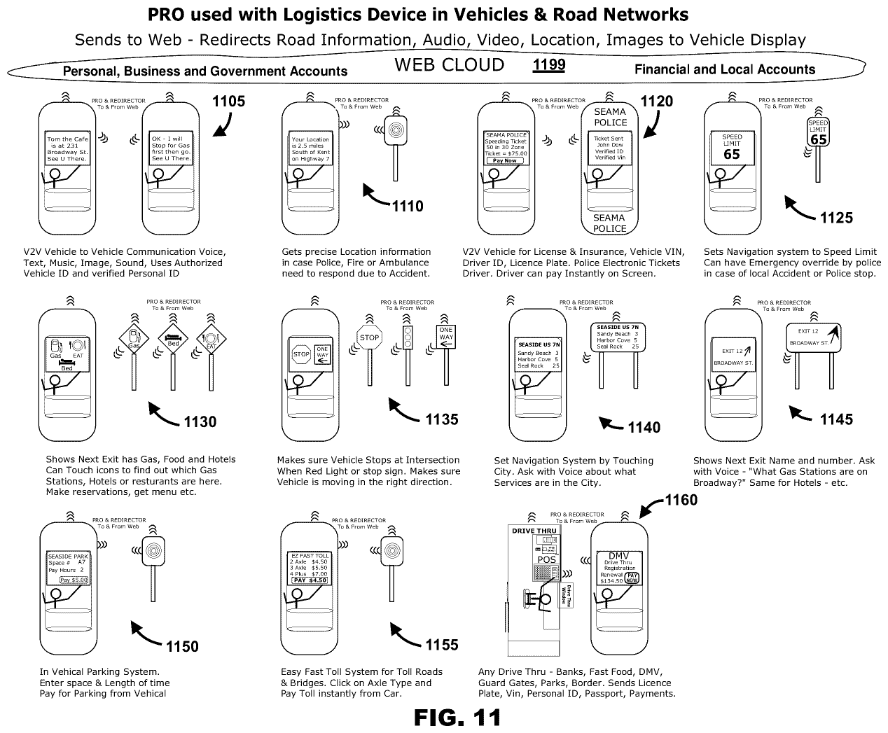

FIG. 11 is a set of diagrams showing other examples wherein the exemplary system is utilized to assist in vehicle (e.g., location) and road networks, etc. For example, 1105 shows a scenario where the exemplary system can provide as a “redirection” gateway via Cloud 1199 (containing one or more supporting databases) for vehicle-to-different-vehicle communication. 1110 shows connection of a vehicle to its ignition key for vehicle location, as well as for example for police location, notification, or other needs. Example 1120 illustrates an embodiment facilitating automatic vehicle-related payments, such as tolls, etc. Example 1125 illustrates an embodiment facilitating vehicle speed/limits and police notifications. Example 1130 illustrates an embodiment facilitating navigation related information (interests, restaurants, gas stations, etc.) and the facilitation of nav-based purchases. Example 1135 illustrates an embodiment wherein various traffic directing devices (e.g., stoplight, etc.) are in communication to the PRO device (or app) and assist in navigation. Example 1140 illustrates an embodiment facilitating travel information acquisition, using voice activation and control. Example 1145 illustrates an embodiment facilitating real time navigation of the same. Example 1150 illustrates an embodiment facilitating parking payment. Example 1155 illustrates an embodiment facilitating toll road payment information. Example 1160 illustrates an embodiment facilitating various mobile payment scenarios related, for example, for DMV transactions.

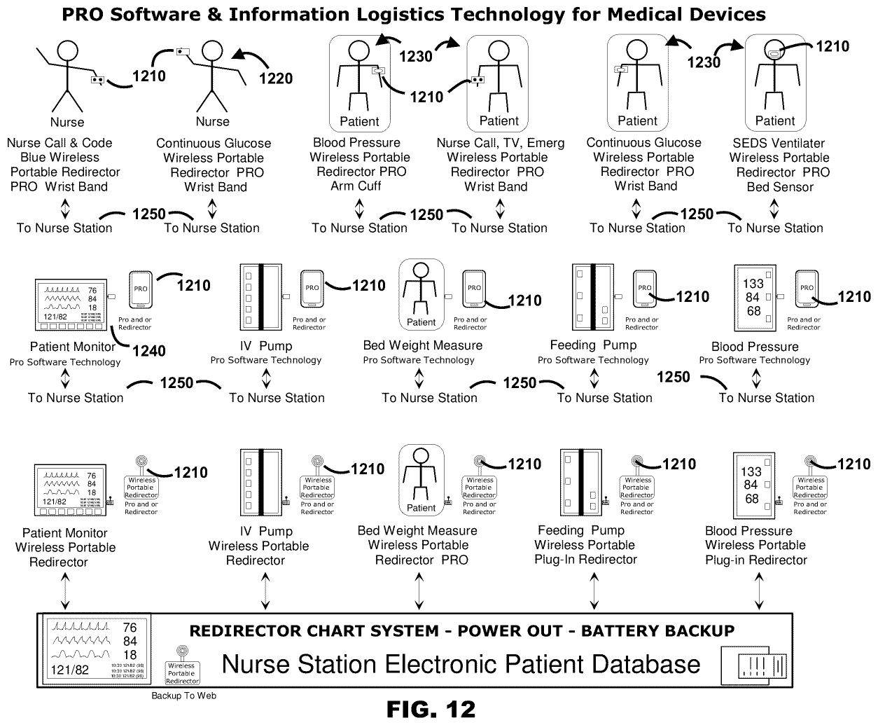

FIG. 12 is a set of diagrams showing other examples wherein the exemplary system is utilized to help facilitate medical treatment. Each medical technician/nurse/doctor, etc. 1220 is in possession of an exemplary “mobile” PRO device 1210, being connected to a PRO-enabled base “nurse” station 1250, having various medical tracking equipment and monitoring. Examples of such sensing, medical measurements are described in the various scenarios in FIG. 12. In some embodiments, the mobile PRO system 1210 may be used by the patient him/herself 1230, wherein the mobile PRO system 1210 is in communication with one or more “nurse” station(s) (e.g., monitoring device), operating as an interface (aka—providing wireless capabilities and data management) from the patient-located device to the base/nurse station 1250.

In various embodiments, the mobile PRO system 1210 can again act as a gateway to other devices. For example, a patient monitor 1240 (or IV pump, or Bed Weight, Feeding, Blood Pressure, etc.) having PRO software can interface with both the mobile PRO system 1210 and a “nurse” station 1250. It is understood, that in some embodiments, the supporting PRO software may be installed on the various other medical devices (e.g., nurse station, etc.) to provide an integrated system between the various functions being accomplished with the various equipment. As noted above, some of the supporting software may be located in a remote site, for example, a Cloud or Patient Database, interacting with the various exemplary PRO-enabled devices.

All of the above examples shown in FIGS. 9-12 can utilize various aspects detailed in the prior Figures' description to enable and arrive at the objectives shown. While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. An information logistics system requiring no alteration of a transaction generating device, comprising:
a first device generating information output in at least one of a wired and wireless mode; and
a logistics device configured to receive the generated information from the first device, the logistics device in at least one of wired and wireless communication to one or more targeted destination devices,
wherein the generated information from the first device is automatically forwarded to the one or more targeted destination devices by the logistics device.

2. The information logistics system of claim 1, wherein the first device is at least one of a printer, payment terminal, computer, mobile smart phone, and point-of-sale (POS) device disposed in at least one of an office, home, retail space, financial institution, government institution, restaurant, and transportation vehicle.

3. The information logistics system of claim 1, wherein a target-destination information is originated from a software program resident on the logistics device.

4. The information logistics system of claim 1, wherein the generated information is forwarded to the one or more targeted destination devices through an intermediate network, connected to both the first device and the logistics device.

5. The information logistics system of claim 1, wherein the intermediate network is the Internet, wherein the generated information is serviced by servers in a Cloud.

6. The information logistics system of claim 1, wherein the generated information from the first device is in at least one of digital and analog form containing at least one of a receipt, rebate, ticket, invoice, image, video, media, email, SMS, coupon, music, financial information, gift card, refund, money transaction, block chain, token, cryptocurrency, bitcoin, login information, software command, and GPS.

7. The information logistics system of claim 1, wherein the logistics device contains a wireless transceiver and utilizes at least one of short range and long range protocols, and is at least one of a computer, a smart phone, and a software programing running on a digital device.

8. The information logistics system of claim 1, wherein a target-destination information for the logistics device is obtained via at least one of the first device, a data reader, voice command, an app, and a third device.

9. The information logistics system of claim 8, wherein third device is at least one of a traffic, navigation, location sensing, security, medical, and financial information device.

10. The information logistics system of claim 1, wherein the first device is at least one of a payment terminal and a transaction terminal.

11. The information logistics system of claim 1, wherein the first device is located in a mode of transportation and location information is tabulated with printout information.

12. The information logistics system of claim 4, further comprising at least one of a financial service and bank connected to the intermediate network, wherein the generated information is settlement information including an amount of refund due to a transacting party, the amount being transmitted to the at least one financial service and bank.

13. The information logistics system of claim 1, wherein the generated information is in an encrypted form prior to transmission or decrypted form after receipt.

14. The information logistics system of claim 1, wherein the logistics device is utilized in an existing financial payment transaction processing system.

15. The information logistics system of claim 1, wherein the generated information is forwarded in at least one of a format as an email, text message, and facsimile to a recipient device connected to at least one of an internet network and cell phone network.

16. The information logistics system of claim 1, wherein the generated information is in a form of at least one of a musical data file, voice data file, image file and video data file.

17. The information logistics system of claim 1, wherein the generated information is output to the logistics device via a wired data port.

18. The information logistics system of claim 1, wherein at least one of a time stamp, date, activity location, activity code, and merchant number is in the generated information and a servicing computer connected to the logistics device validates the generated information as authentic.

19. A method to redirect information output locally from a transaction device to non-local secondary devices without requiring an alteration of the transaction device, comprising:
generating information from a first transaction device;
outputting in at least one of a wired and wireless mode the generated information from the first transaction device;
receiving by a logistics device the generated information from the first transaction device, wherein the logistics device in communication to one or more targeted destination devices; and
automatically forwarding the received generated information to one or more targeted destination devices by the logistics device.

20. The method of claim 19, further comprising, receiving the generated information from the logistics device by a server within a network Cloud, wherein the server forwards the generated information to the one or more targeted destination devices.
